(19) United States
(12) Patent Application Publication
(10) Pub. No.: US 2014/0223521 A1
(43) Pub. Date: Aug. 7, 2014

(54) ALLOWING ACCESS TO UNDERLYING HARDWARE CONSOLES TO CORRECT PROBLEMS EXPERIENCING BY USER

(71) Applicant: INTERNATIONAL BUSINESS MACHINES CORPORATION, (US)

(72) Inventors: Rohith K. Ashok, Apex, NC (US); Roy F. Brabson, Raleigh, NC (US); Jeremy R. Geddes, Raleigh, NC (US); Hugh E. Hockett, Raleigh, NC (US); Matthew J. Sheard, Morrisville, NC (US)

(73) Assignee: INTERNATIONAL BUSINESS MACHINES CORPORATION, Armonk, NY (US)

(21) Appl. No.: 13/759,168

(22) Filed: Feb. 5, 2013

(51) Int. Cl. H04L 29/06

(52) U.S. Cl. CPC H04L 63/083
USPC 726/5

(57) ABSTRACT

A method, system and computer program product for providing access to underlying hardware consoles to correct problems experiencing by a user. The administrative server receives a request from the user to access a managing system configured to provide access to the underlying hardware consoles that are combined together to service a user's computing requirements. The administrative server presents a list of managing systems for the user to connect that were identified as being able to address the problem(s) the user is experiencing. The administrative server then enables access to managing systems selected in the list in response to the user providing appropriate authentication credentials. An interface is then provided to the user by the selected managing systems to select the underlying hardware consoles to access. In this manner, the user is provided access to the underlying hardware consoles in an easy manner without presenting numerous options and configurations.

### TECHNICAL FIELD

The present invention relates generally to cloud computing, and more particularly to allowing access to underling hardware consoles to correct problems experiencing by user.

### BACKGROUND

In a cloud computing environment, computing is delivered as a service rather than a product, whereby shared resources, software and information are provided to computers and other devices as a metered service over a network, such as the Internet. In such an environment, computation, software, data access and storage services are provided to users that do not require knowledge of the physical location and configuration of the system that delivers the services.

The functions of the cloud computing environment are performed by a data center, which includes disparate hardware components (e.g., storage controllers, network switches, physical compute machines) which are integrated amongst each other. Each of these components may have different interfaces to manage the particular component. For example, storage controllers may have a web based and Command Line Interface (CLI) based interface. Network switches and physical compute machines may have other different interfaces. In many cases, there are multiples interfaces for each component.

When these hardware components are combined together to service the user's computing requirements, not all of the features of these components are used by the user. In some cases, the features of the components may actually conflict with each other. Attempts have been made to assist the user in managing the components so as to more effectively utilize the components, such as to correct problems experiencing by the user in servicing the user's computing requirements. However, such management products present numerous options and configurations that make it difficult for the user to effectively manage the components.

### BRIEF SUMMARY

In one embodiment of the present invention, a method for providing access to underlying hardware consoles to correct problems experiencing by a user comprises receiving a request to access a managing system, where the managing system is configured to provide access to underlying hardware consoles that are combined together to service the user's computing requirements. The method further comprises identifying one or more managing systems to address problems in servicing the user's computing requirements in response to authenticating the user to access the managing system. Additionally, the method comprises presenting a list of the identified one or more managing systems for the user to connect. Furthermore, the method comprises receiving a selection of one or more managing systems from the list of one or more managing systems. The method additionally comprises enabling the user access to the selected one or more managing systems in response to providing appropriate authentication credentials. In addition, the method comprises providing, by a processor, an interface for the user to select one or more of the underlying hardware consoles to access.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a network system configured in accordance with an embodiment of the present invention;

FIG. 2 illustrates a cloud computing environment in accordance with an embodiment of the present invention.

FIG. 3 illustrates a cloud computing node comprised of one or more cloud construction blocks in accordance with an embodiment of the present invention;

FIG. 4 illustrates a physical layout of a cloud construction block in accordance with an embodiment of the present invention;

FIG. 5 illustrates a hardware configuration of the administrative server and the advanced manager configured in accordance with an embodiment of the present invention;

FIG. 6 is a flowchart of a method for providing a password to the user used to access the advanced manager in accordance with an embodiment of the present invention; and

FIG. 7 is a flowchart of a method for providing the user access to the underlying hardware consoles to correct problems experiencing by the user in accordance with an embodiment of the present invention.

### DETAILED DESCRIPTION

The present invention comprises a method, system and computer program product for providing access to underlying hardware consoles to correct problems experiencing by a user. In one embodiment of the present invention, the administrative server receives a request from the user to access a managing system (referred to herein as the “advanced manager”) (an advanced manager is configured to provide access to the underlying hardware consoles that are combined together to service a user's computing requirements). The administrative server presents a list of one or more advanced managers for the user to connect that were identified as being able to address the problem(s) the user is experiencing (e.g., problems in servicing the user's computing requirements) based on the current state of the system. The administrative server receives a selection of one or more advanced managers from the list of advanced managers. The administrative server then enables access to the selected advanced managers in response to the user providing appropriate authentication credentials (e.g., password). An interface is then provided to the user by the selected advanced managers to select the underlying hardware consoles to access. In this manner, the user is provided access to the underlying hardware consoles to correct problems experiencing by the user (e.g., problems in servicing the user's computing requirements) without presenting numerous options and configurations so as to allow the user to easily and effectively manage the hardware components used in servicing the user's computing requirements.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

It is understood in advance that although this disclosure includes a detailed description on cloud computing, implementation of the teachings recited herein are not limited to a cloud computing environment. Rather, the embodiments of the present invention are capable of being implemented in conjunction with any type of clustered computing environment now known or later developed.

In any event, the following definitions have been derived from the “The NIST Definition of Cloud Computing” by Peter Mell and Timothy Grance, dated September 2011, which is cited on an Information Disclosure Statement filed herewith, and a copy of which is provided to the U.S. Patent and Trademark Office.

Cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction. This cloud model is composed of five essential characteristics, three service models, and four deployment models.

Characteristics are as follows:

On-Demand Self-Service: A consumer can unilaterally provision computing capabilities, such as server time and network storage, as needed, automatically without requiring human interaction with each service's provider.

Broad Network Access: Capabilities are available over a network and accessed through standard mechanisms that promote use by heterogeneous thin or thick client platforms (e.g., mobile phones, tablets, laptops and workstations).

Resource Pooling: The provider's computing resources are pooled to serve multiple consumers using a multi-tenant model, with different physical and virtual resources dynamically assigned and reassigned according to consumer demand. There is a sense of location independence in that the consumer generally has no control or knowledge over the exact location of the provided resources but may be able to specify location at a higher level of abstraction (e.g., country, state or data center). Examples of resources include storage, processing, memory and network bandwidth.

Rapid Elasticity: Capabilities can be elastically provisioned and released, in some cases automatically, to scale rapidly outward and inward commensurate with demand. To the consumer, the capabilities available for provisioning often appear to be unlimited and can be purchased in any quantity at any time.

Measured Service: Cloud systems automatically control and optimize resource use by leveraging a metering capability at some level of abstraction appropriate to the type of service (e.g., storage, processing, bandwidth and active user accounts). Resource usage can be monitored, controlled and reported providing transparency for both the provider and consumer of the utilized service.

Service Models are as follows:

Software as a Service (SaaS): The capability provided to the consumer is to use the provider's applications running on a cloud infrastructure. The applications are accessible from various client devices through either a thin client interface, such as a web browser (e.g., web-based e-mail) or a program interface. The consumer does not manage or control the underlying cloud infrastructure including network, servers, operating systems, storage, or even individual application capabilities, with the possible exception of limited user-specific application configuration settings.

Platform as a Service (PaaS): The capability provided to the consumer is to deploy onto the cloud infrastructure consumer-created or acquired applications created using programming languages, libraries, services and tools supported by the provider. The consumer does not manage or control the underlying cloud infrastructure including networks, servers, operating systems or storage, but has control over the deployed applications and possibly configuration settings for the application-hosting environment.

Infrastructure as a Service (IaaS): The capability provided to the consumer is to provision processing, storage, networks and other fundamental computing resources where the consumer is able to deploy and run arbitrary software, which can include operating systems and applications. The consumer does not manage or control the underlying cloud infrastructure but has control over operating systems, storage and deployed applications; and possibly limited control of select networking components (e.g., host firewalls).

Deployment Models are as follows:

Private Cloud: The cloud infrastructure is provisioned for exclusive use by a single organization comprising multiple consumers (e.g., business units). It may be owned, managed and operated by the organization, a third party or some combination of them, and it may exist on or off premises.

Community Cloud: The cloud infrastructure is provisioned for exclusive use by a specific community of consumers from organizations that have shared concerns (e.g., mission, security requirements, policy and compliance considerations). It may be owned, managed and operated by one or more of the organizations in the community, a third party, or some combination of them, and it may exist on or off premises.

Public Cloud: The cloud infrastructure is provisioned for open use by the general public. It may be owned, managed and operated by a business, academic or government organization, or some combination of them. It exists on the premises of the cloud provider.

Hybrid Cloud: The cloud infrastructure is a composition of two or more distinct cloud infrastructures (private, community or public) that remain unique entities, but are bound together by standardized or proprietary technology that enables data and application portability (e.g., cloud bursting for load balancing between clouds).

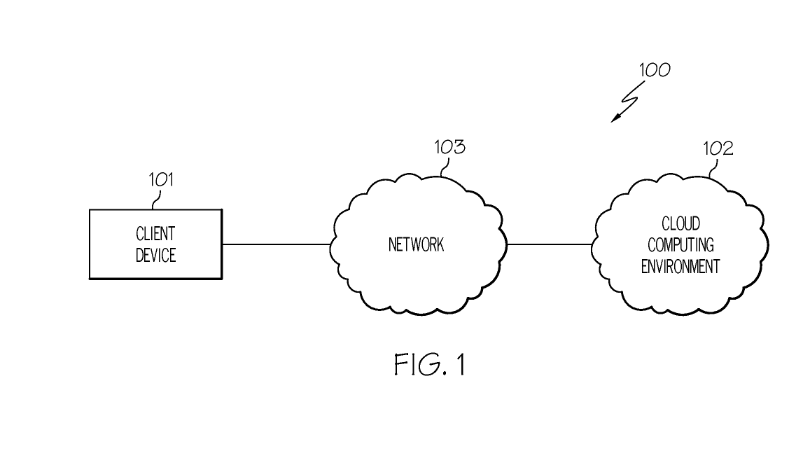

Referring now to the Figures in detail, FIG. 1 illustrates a network system 100 configured in accordance with an embodiment of the present invention. Network system 100 includes a client device 101 connected to a cloud computing environment 102 via a network 103. Client device 101 may be any type of computing device (e.g., portable computing unit, Personal Digital Assistant (PDA), smartphone, laptop computer, mobile phone, navigation device, game console, desktop computer system, workstation, Internet appliance and the like) configured with the capability of connecting to cloud computing environment 102 via network 103.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

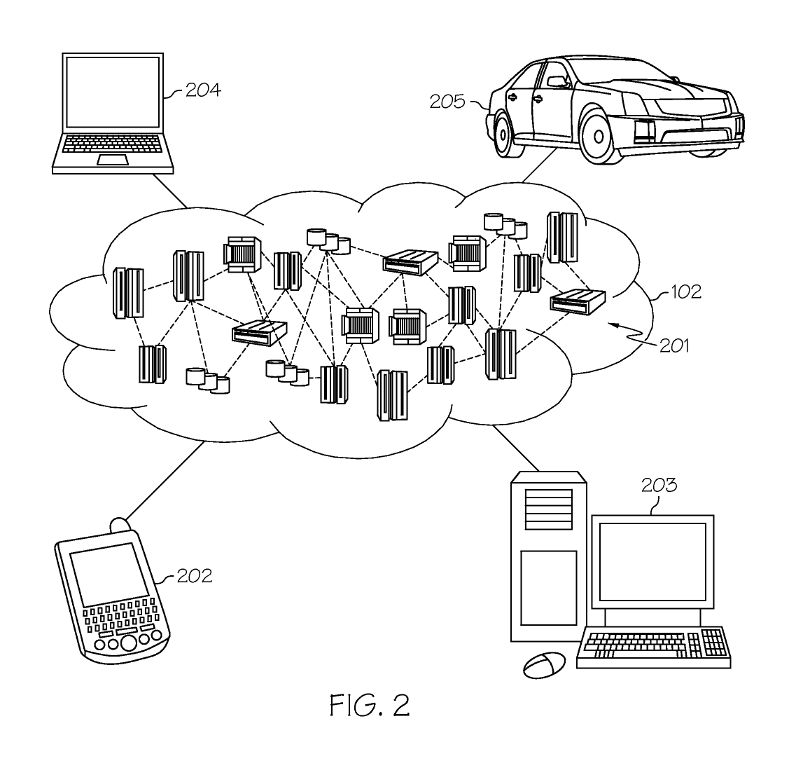

Cloud computing environment 102 is used to deliver computing as a service to client device 101 implementing the model discussed above. An embodiment of cloud computing environment 102 is discussed below in connection with FIG. 2.

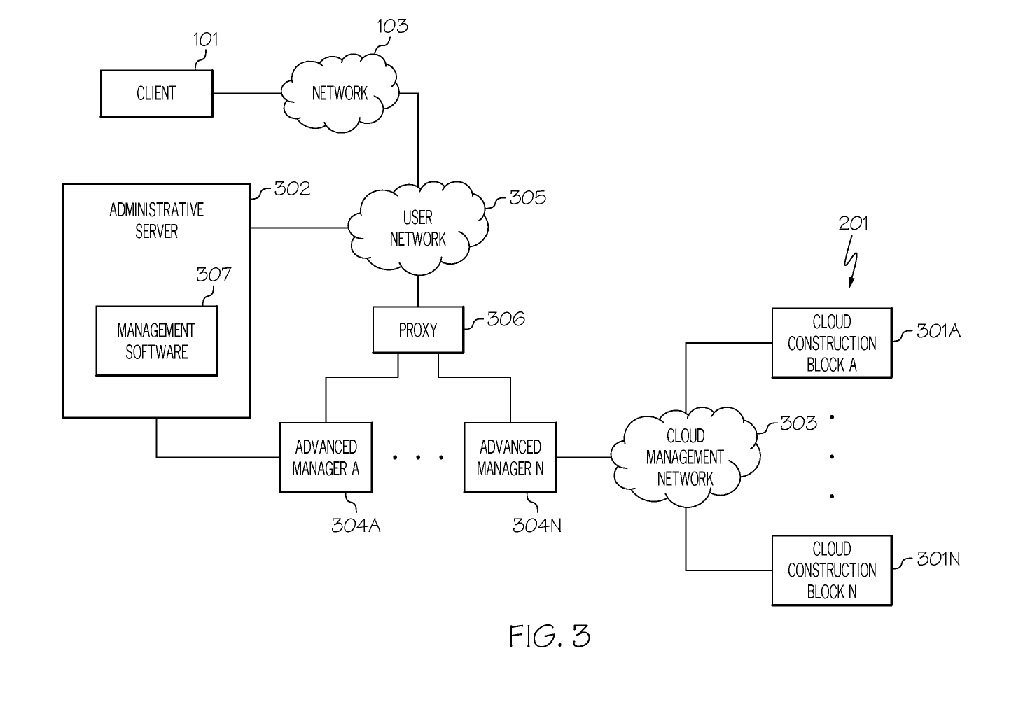

FIG. 2 illustrates cloud computing environment 102 in accordance with an embodiment of the present invention. As shown, cloud computing environment 102 includes one or more cloud computing nodes 201 (also referred to as “clusters”) with which local computing devices used by cloud consumers, such as, for example, Personal Digital Assistant (PDA) or cellular telephone 202, desktop computer 203, laptop computer 204, and/or automobile computer system 205 may communicate. Nodes 201 may communicate with one another. They may be grouped (not shown) physically or virtually, in one or more networks, such as Private, Community, Public, or Hybrid clouds as described hereinabove, or a combination thereof. This allows cloud computing environment 102 to offer infrastructure, platforms and/or software as services for which a cloud consumer does not need to maintain resources on a local computing device. A description of a schematic of exemplary cloud computing nodes 201 is provided below in connection with FIG. 3. It is understood that the types of computing devices 202, 203, 204, 205 shown in FIG. 2, which may represent client device 101 of FIG. 1, are intended to be illustrative and that cloud computing nodes 201 and cloud computing environment 102 can communicate with any type of computerized device over any type of network and/or network addressable connection (e.g., using a web browser). Program code located on one of nodes 201 may be stored on a computer recordable storage medium in one of nodes 201 and downloaded to computing devices 202, 203, 204, 205 over a network for use in these computing devices. For example, a server computer in computing node 201 may store program code on a computer readable storage medium on the server computer. The server computer may download the program code to computing device 202, 203, 204, 205 for use on the computing device.

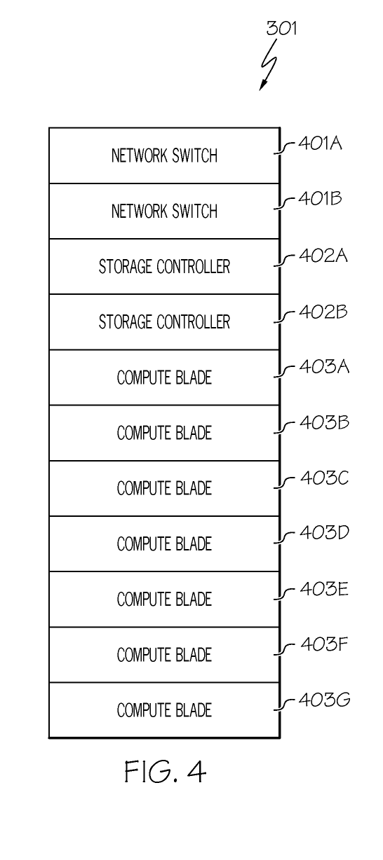

Referring now to FIG. 3, FIG. 3 illustrates a schematic of a cloud computing node 201 comprised of one or more “cloud construction blocks” 301A-301N in accordance with an embodiment of the present invention. Cloud construction blocks 301A-301N may collectively or individually be referred to as cloud construction blocks 301 or cloud construction block 301, respectively. Each cloud construction block 301 may be represented by a single unit that includes disparate hardware components (e.g., storage controllers, network switches, physical compute machines) which are integrated amongst each other as illustrated in FIG. 4.

Referring now to FIG. 4, FIG. 4 illustrates a physical layout of a cloud construction block 301 in accordance with an embodiment of the present invention. Referring to FIG. 4, cloud construction block 301 may comprise a rack of many units containing network hardware (e.g., network switches 401A, 401B), storage hardware (e.g., storage controllers 402A, 402B), and compute hardware (e.g., compute blades 403A-403G). Network switches 401-401B may collectively or individually be referred to as network switches 401 or network switch 401, respectively. Storage controllers 402A-402B may collectively or individually be referred to as storage controllers 402 or storage controller 402. Compute blades 403A-403G may collectively or individually be referred to as compute blades 403 or compute blade 403, respectively.

While FIG. 4 illustrates cloud construction block 301 as comprising a particular number of network switches 401, storage controllers 402 and compute blades 403, cloud construction block 301 is not to be limited in scope to the particular number of components depicted in FIG. 1. Furthermore, cloud construction block 301 may include other components, including software, that were not depicted for ease of understanding the principles of the present invention.

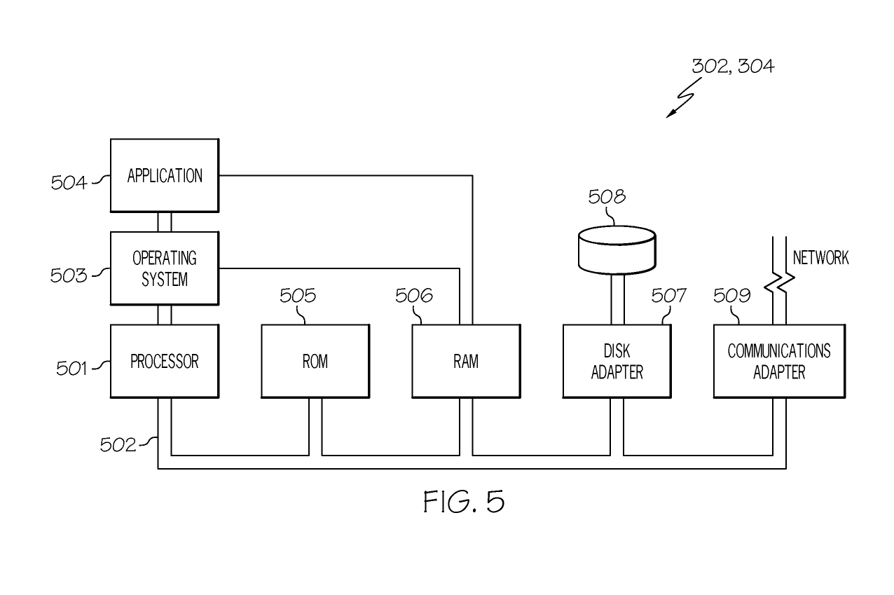

Returning back to FIG. 3, cloud computing node 201 is connected to an administrative server 302 via a private network, referred to herein as the “cloud management network” 303. Administrative server 302 is configured to provide data center-level functions. A description of the hardware configuration of administrative server 302 is provided further below in connection with FIG. 5.

FIG. 3 further illustrates one or more systems, referred to herein as “advanced managers” 304A-304N (also referred to as “managing systems”), that are connected to cloud construction blocks 301 via cloud management network 303 as well as connected to administrative server 302. Advanced managers 304A-304N may collectively or individually be referred to as advanced managers 304 or advanced manager 304, respectively. Each advanced manager 304 is configured to provide access to the user of client 101 (FIG. 1) to the underlying “hardware consoles” (referring to the hardware components 401, 402, 403 depicted in FIG. 4) that are combined together to service the user's computing requirements. A description of the hardware configuration of advanced manager 304 is provided further below in connection with FIG. 5.

As further illustrated in FIG. 3, the user of client 101 is able to access administrative server 302 via a user network 305, where the user network 305 is accessible by client 101 via an outside network 103 (FIG. 1). User network 305 is a public network; whereas, cloud management network 303 is a private network that uses private Internet Protocol (IP) space. Furthermore, cloud management network 303 is isolated from user network 305 as well as not connected to an external network.

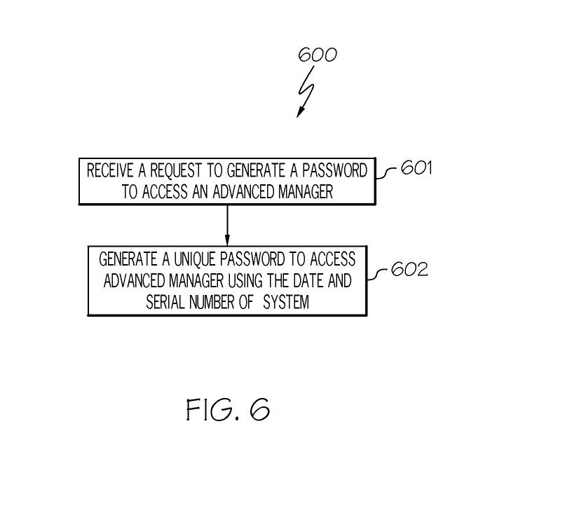

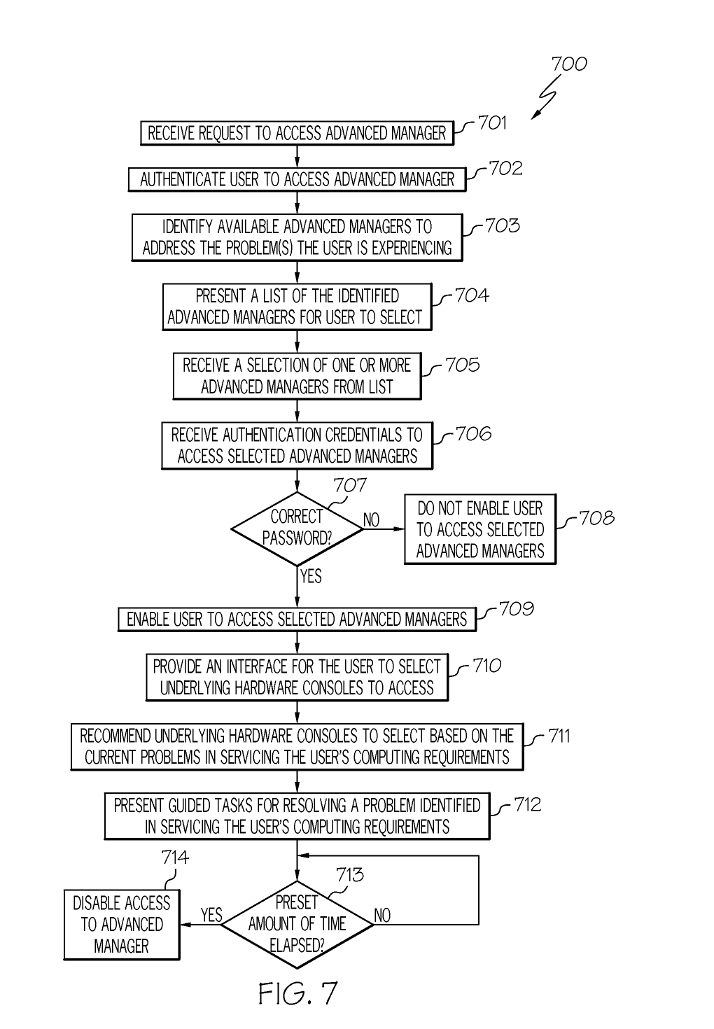

As will be discussed in greater detail in connection with FIGS. 6-7, the user of client 101 will request access to advanced manager 304 which provides access to the underlying hardware consoles. In order to access the underlying hardware consoles, the user needs to be provided with authentication credentials (e.g., password). To use advanced manager 304, the user of client 101 needs to be authenticated by administrative server 302 and provide the authentication credentials (e.g., password) (a second level of security). After being authorized to directly access advanced managers 304, data is forwarded from the user to advanced manager 304 via a proxy 306 (e.g., proxy server). A more detailed discussion of the user accessing the underlying hardware consoles to correct problems experiencing by the user using the components of FIG. 3 is provided further below in connection with FIGS. 6-7.

Referring again to FIG. 3, in some embodiments, administrative server 301 supports a module, referred to herein as the management software 307, that can be used to manage all the hardware components of cloud computing nodes 201, monitor utilization of resources (e.g., memory, processor, disk, network) by virtual machines, intelligently deploy images of data and optimize the operations of cloud computing environment 102. Furthermore, management software 307 is configured to provide the user access to advanced manager 304 as discussed in further detail below in connection with FIGS. 6-7.

Referring now to FIG. 5, FIG. 5 illustrates a hardware configuration of administrative server 302 (FIG. 3), advanced manager 304 (FIG. 3) which is representative of a hardware environment for practicing the present invention. Administrative server 302, advanced manager 304 have a processor 501 coupled to various other components by system bus 502. An operating system 503 runs on processor 501 and provides control and coordinates the functions of the various components of FIG. 5. An application 504 in accordance with the principles of the present invention runs in conjunction with operating system 503 and provides calls to operating system 503 where the calls implement the various functions or services to be performed by application 504. Application 504 of administrative server 302 may include, for example, a program (e.g., management software 307) for providing the user access to advanced manager 304 as discussed further below in association with FIGS. 6-7. Furthermore, application 504 of advanced manager 304 may include, for example, a program for providing access to the user to the underlying hardware consoles to correct problems experiencing by the user (e.g., problems in servicing the user's computing requirements) as discussed further below in association with FIG. 7.

Referring again to FIG. 5, read-only memory (“ROM”) 505 is coupled to system bus 502 and includes a basic input/output system (“BIOS”) that controls certain basic functions of administrative server 302, advanced manager 304. Random access memory (“RAM”) 506 and disk adapter 507 are also coupled to system bus 502. It should be noted that software components including operating system 503 and application 504 may be loaded into RAM 506, which may be administrative server's 302, advanced manager's 304 main memory for execution. Disk adapter 507 may be an integrated drive electronics (“IDE”) adapter that communicates with a disk unit 508, e.g., disk drive. It is noted that the program of administrative server 302 for providing the user access to advanced manager 304, as discussed further below in association with FIGS. 6-7, may reside in disk unit 508 or in application 504. It is further noted that the program of advanced manager 304 for providing access to the user to the underlying hardware consoles to correct problems experiencing by the user, as discussed further below in association with FIG. 7, may reside in disk unit 508 or in application 504.

Administrative server 302, advanced manager 304 may further include a communications adapter 509 coupled to bus 502. Communications adapter 509 interconnects bus 502 with a network (e.g., network 103 of FIG. 1, networks 303 and 305 of FIG. 3).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, the functions of the cloud computing environment are performed by a data center, which includes disparate hardware components (e.g., storage controllers, network switches, physical compute machines) which are integrated amongst each other. Each of these components may have different interfaces to manage the particular component. For example, storage controllers may have a web based and Command Line Interface (CLI) based interface. Network switches and physical compute machines may have other different interfaces. In many cases, there are multiples interfaces for each component. When these hardware components are combined together to service the user's computing requirements, not all of the features of these components are used by the user. In some cases, the features of the components may actually conflict with each other. Attempts have been made to assist the user in managing the components so as to more effectively utilize the components, such as to correct problems experiencing by the user in servicing the user's computing requirements. However, such management products present numerous options and configurations that make it difficult for the user to effectively manage the components.

The principles of the present invention provide a means for providing a user access to the underlying hardware consoles to correct problems experiencing by the user (e.g., problems in servicing the user's computing requirements) without presenting numerous options and configurations so as to allow the user to easily and effectively manage the hardware components used in servicing the user's computing requirements as discussed below in connection with FIGS. 6 and 7. FIG. 6 is a flowchart of a method for providing a password to the user of client 101 used to access advanced manager 304 (FIG. 3) configured to provide access to the underlying hardware consoles to correct problems experiencing by the user (e.g., problems in servicing the user's computing requirements). FIG. 7 is a flowchart of a method for providing the user access to the underlying hardware consoles to correct problems experiencing by the user.

As stated above, FIG. 6 is a flowchart of a method 600 for providing a password to the user of client 101 used to access advanced manager 304 (FIG. 3) configured to provide access to the underlying hardware consoles to correct problems experiencing by the user in accordance with an embodiment of the present invention.

Referring to FIG. 6, in conjunction with FIGS. 1-5, in step 601, administrative server 302 receives a request to generate a password to access advanced manager 304, where advanced manager 304 is configured to provide access to the underlying hardware consoles that are combined together to service the user's computing requirements. In one embodiment, the user logs into the system (e.g., the hardware components, such as hardware components 401, 402, 403, that may reside in a single unit (rack) that is used to service the user's computing requirements) using the user's own credentials to enable its service account to generate a key which is used by administrative server 302 to generate a password to access advanced manager 304 as discussed below.

In step 602, administrative server 302 generates a unique password to access advanced manager 304. In one embodiment, administrative server 302 generates a unique password to access advanced manager 304 using the date and serial number of the system (e.g., the hardware components, such as hardware components 401, 402, 403, that may reside in a single unit (rack) that is used to service the user's computing requirements) as well as the key discussed above. In this manner, a two stage authentication process is implemented.

In some implementations, method 600 may include other and/or additional steps that, for clarity, are not depicted. Further, in some implementations, method 600 may be executed in a different order presented and that the order presented in the discussion of FIG. 6 is illustrative. Additionally, in some implementations, certain steps in method 600 may be executed in a substantially simultaneous manner or may be omitted.

Once the user has the password to access advanced manager 304, the user may access the advanced manager 304 in order to access the underlying hardware consoles to correct problems experiencing by the user as discussed below in connection with FIG. 7.

FIG. 7 is a flowchart of a method 700 for providing the user access to the underlying hardware consoles to correct problems experiencing by a user in accordance with an embodiment of the present invention.

Referring to FIG. 7, in conjunction with FIGS. 1-5, in step 701, administrative server 302 receives a request to access advanced manager 304 from a user of client 101. As discussed above, advanced manager 304 is configured to provide access to the underlying “hardware consoles” (referring to the hardware components 401, 402, 403 depicted in FIG. 4) that are combined together to service the user's computing requirements.

In step 702, administrative server 302 authenticates the user of client 101 to access advanced manager 304.

In response to authenticating the user, administrative server 302, in step 703, identifies one or more advanced managers 304 to address the problem(s) the user is experiencing (e.g., problems in servicing the user's computing requirements) based on the current state of the system (e.g., the hardware components, such as hardware components 401, 402, 403, that may reside in a single unit that is used to service the user's computing requirements). By specifically identifying the advanced managers 304 to address the problem(s) the user is experiencing, the user will not be presented with numerous options and configurations thereby allowing the user to easily and effectively manage the hardware components used in servicing the user's computing requirements as discussed below.

In step 704, administrative server 302 presents a list of the identified advanced managers 304 (those advanced managers 304 identified in step 703) for the user to select. In one embodiment, the advanced managers 304 that are presented to the user are those advanced managers 304 that can resolve any problem(s) that the user is experiencing (e.g., problems in servicing the user's computing requirements) based on the current state of the system.

In step 705, administrative server 302 receives a selection of one or more advanced managers 304 from the list of advanced managers 304 presented to the user in step 704. In one embodiment, the user may also select the protocol (e.g., Secure Shell (SSH), Hypertext Transfer Protocol Secure (HTTPS)) to be used for accessing the selected advanced manager(s) 304.

In step 706, administrative server 302 receives authentication credentials (e.g., password) to access the selected advanced managers 304. By requiring the user to be authenticated by administrative server 302 as well as requiring the user to provide authentication credentials (e.g., password) to access advanced manager(s) 304, two levels of security are implemented.

In step 707, a determination is made by administrative server 302 as to whether it received the correct password. If administrative server 302 did not receive the correct password, then, in step 708, administrative server 302 does not enable the user of client 101 to access the selected advanced managers 304.

If, however, administrative server 302 receives the correct password, then, in step 709, administrative server 302 enables the user of client 101 to access the selected advanced managers 304. As discussed above, advanced managers 304 provide access to the underlying hardware consoles that are combined together to service the user's computing requirements. In this manner, the user is provided access to the underlying hardware consoles to correct problems experiencing by the user (e.g., problems in servicing the user's computing requirements) without presenting numerous options and configurations so as to allow the user to easily and effectively manage the hardware components used in servicing the user's computing requirements.

In one embodiment, administrative server 302 opens a socket that listens on an ephemeral port (short-lived transport protocol port for Internet Protocol (IP) communications) and passes the port to the user of client 101. The user of client 101 may then connect to administrative server 302. Once client 101 connects to administrative server 302, administrative server 302 opens a socket connection to the selected advanced managers 304 using the IP address and port for the advanced managers 304. In the case of a single-session protocol, such as SSH, the listening port is then closed. For multi-session protocols, such as HTTPS, the listening socket is left open for additional connections.

In one embodiment, a proxy 306 is configured to forward all data received from client 101 to the selected advanced managers 304. In the case of encrypted data, it is not decrypted at proxy 306 but passed as-is from client 101 to the selected advanced managers 304.

In step 710, the selected advanced managers 304 provide an interface for the user of client 101 to select the underlying hardware consoles to access. In one embodiment, a hardware map is presented on the interface of client 101 that graphically displays the individual hardware components (e.g., hardware components 401, 402, 403) inside the cloud computing rack. In response to the user clicking on a hardware component, the user is presented with the option of opening the underlying hardware console.

Optionally, in step 711, the selected advanced managers 304 recommend to the user of client 101 underlying hardware consoles to select based on the current problems in servicing the user's computing requirements.

Optionally, in step 712, the selected advanced managers 304 present guided tasks to the user of client 101 for resolving a problem identified in servicing the user's computing requirements.

In step 713, a determination is made by administrative server 302 as to whether a preset amount of time has elapsed. If a preset amount of time has not elapsed, then administrative server 302 continues to determine whether a preset amount of time has elapsed in step 713.

If, however, a preset amount of time has elapsed, then, in step 714, administrative server 302 disables access to the selected advanced managers 304.

In some implementations, method 700 may include other and/or additional steps that, for clarity, are not depicted. Further, in some implementations, method 700 may be executed in a different order presented and that the order presented in the discussion of FIG. 7 is illustrative. Additionally, in some implementations, certain steps in method 700 may be executed in a substantially simultaneous manner or may be omitted.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for providing access to underlying hardware consoles to correct problems experiencing by a user, the method comprising:
receiving a request to access a managing system, wherein said managing system is configured to provide access to underlying hardware consoles that are combined together to service computing requirements of said user;
identifying one or more managing systems to address problems in servicing said user's computing requirements in response to authenticating said user to access said managing system;
presenting a list of said identified one or more managing systems for said user to connect;
receiving a selection of one or more managing systems from said list of one or more managing systems;
enabling said user access to said selected one or more managing systems in response to receiving appropriate authentication credentials; and
providing, by a processor, an interface for said user to select one or more of said underlying hardware consoles to access.

2. The method as recited in claim 1 further comprising:
recommending underlying hardware consoles to select based on said problems in servicing said user's computing requirements.

3. The method as recited in claim 1 further comprising:
presenting guided tasks to said user for resolving a problem identified in servicing said user's computing requirements.

4. The method as recited in claim 1 further comprising:
disabling access to said selected one or more managing systems in response to a preset time elapsing.

5. The method as recited in claim 1, wherein said authentication credentials comprise a password.

6. The method as recited in claim 1 further comprising:
forwarding data received from said user to said selected one or more managing systems via a proxy.

7. A computer program product embodied in a computer readable storage device for providing access to underlying hardware consoles to correct problems experiencing by a user, the computer program product comprising the programming instructions for:
receiving a request to access a managing system, wherein said managing system is configured to provide access to underlying hardware consoles that are combined together to service computing requirements of said user;
identifying one or more managing systems to address problems in servicing said user's computing requirements in response to authenticating said user to access said managing system;
presenting a list of said identified one or more managing systems for said user to connect;
receiving a selection of one or more managing systems from said list of one or more managing systems; and
enabling said user access to said selected one or more managing systems in response to receiving appropriate authentication credentials, wherein said selected one or more managing systems provide an interface for said user to select one or more of said underlying hardware consoles to access.

8. The computer program product as recited in claim 7, wherein said selected one or more managing systems recommend underlying hardware consoles to select based on said problems in servicing said user's computing requirements.

9. The computer program product as recited in claim 7, wherein said selected one or more managing systems present guided tasks to said user for resolving a problem identified in servicing said user's computing requirements.

10. The computer program product as recited in claim 7 further comprising the programming instructions for:
disabling access to said selected one or more managing systems in response to a preset time elapsing.

11. The computer program product as recited in claim 7, wherein said authentication credentials comprise a password.

12. A system, comprising:
an administrative server configured to manage hardware components of a cloud computing environment, wherein said administrative server comprises:
a memory unit for storing a computer program for providing a user access to one or more managing systems configured to provide access to underlying hardware consoles to correct problems experiencing by said user, wherein said underlying hardware consoles are combined together to service computing requirements of said user; and
a processor coupled to said memory unit, wherein said processor, responsive to said computer program, comprises:
circuitry for receiving a request to access a managing system;
circuitry for identifying one or more managing systems to address problems in servicing said user's computing requirements in response to authenticating said user to access said managing system;
circuitry for presenting a list of said identified one or more managing systems for said user to connect;
circuitry for receiving a selection of one or more managing systems from said list of one or more managing systems; and
circuitry for enabling said user access to said selected one or more managing systems in response to receiving appropriate authentication credentials, wherein said selected one or more managing systems provide an interface for said user to select one or more of said underlying hardware consoles to access.

13. The system as recited in claim 12, wherein said selected one or more managing systems recommend underlying hardware consoles to select based on said problems in servicing said user's computing requirements.

14. The system as recited in claim 12, wherein said selected one or more managing systems present guided tasks to said user for resolving a problem identified in servicing said user's computing requirements.

15. The system as recited in claim 12, wherein said processor further comprises:
circuitry for disabling access to said selected one or more managing systems in response to a preset time elapsing.

16. The system as recited in claim 12, wherein said authentication credentials comprise a password.

17. The system as recited in claim 12 further comprising:
a proxy coupled to said selected one or more managing systems and said administrative server, wherein said proxy forwards data received from said user to said selected one or more managing systems.
